(19) United States
(12) Patent Application Publication
(10) Pub. No.: US 2021/0088942 A1
(43) Pub. Date: Mar. 25, 2021

(54) IMAGE FORMING APPARATUS

(71) Applicant: CANON KABUSHIKI KAISHA, Tokyo (JP)

(72) Inventor: Genta Sato, Kanagawa (JP)

(21) Appl. No.: 17/113,295

(22) Filed: Dec. 7, 2020

Related U.S. Application Data
(63) Continuation of application No. PCT/JP2019/022840, filed on Jun. 4, 2019.

(30) Foreign Application Priority Data
Jun. 8, 2018 (JP) 2018-110747

(51) Int. Cl. G03G 15/16

(52) U.S. Cl. CPC G03G 15/161

(57) ABSTRACT

An image forming apparatus 100 has a constitution including an image bearing member 1 for bearing an image formed with a liquid developer, an intermediary transfer member 10, a secondary transfer means 7, a first cleaning roller 42 contacting an outer peripheral surface of the intermediary transfer member 10 at a first cleaning portion CL1 positioned downstream of a secondary transfer portion N2 with respect to a rotational direction of the intermediary transfer member 10, a first voltage source 48 for applying a voltage of a first polarity to the first cleaning roller 42, a second cleaning roller contacting the outer peripheral surface of the intermediary transfer member 10 at a second cleaning portion CL2 positioned downstream of the first cleaning portion C1 and upstream of a primary transfer portion N1 with respect to the rotational direction of said intermediary transfer member 10, and a second voltage source 49 for applying a voltage of a second polarity opposite to the first polarity, to the second cleaning roller 45.

### TECHNICAL FIELD

The present invention relates to an image forming apparatus, such as a copying machine, or a printer, a facsimile machine, a multi-function machine having a plurality of functions of these machines, in which an image is formed with a liquid developer in which toner particles (toner) are disposed in a liquid carrier (carrier liquid).

### BACKGROUND ART

Conventionally, as an image forming apparatus using an electrophotographic type or the like, a wet image forming apparatus in which an electrostatic latent image formed on an image bearing member is developed with a liquid developer containing toner and a carrier liquid and thus an image is formed has been known. Further, there is an image forming apparatus of an intermediary transfer type in which a toner image formed on an image bearing member is primary-transferred onto an intermediary transfer member, and the toner image is secondary-transferred from the intermediary transfer member onto a recording material such as paper. As the intermediary transfer member, for example, an intermediary transfer belt constituted by an endless belt is used.

In such an image forming apparatus, a part of the toner image on an intermediary transfer belt is not transferred onto the recording material, and toner (transfer residual toner) remains on the intermediary transfer belt. When the transfer residual toner deposits on the intermediary transfer belt, the toner paper powders or the like on a non-image portion of a subsequent image and causes image deterioration. Further, on the intermediary transfer belt, paper powder generated from the recording material and depositing on the recording material deposits. The paper powder includes a filler including calcium carbonate, and pulse and the like. When the paper powder deposits on the intermediary transfer belt, the paper powder is transferred from the intermediary transfer belt onto a photosensitive drum and is interposed or the like between a cleaning member and the photosensitive drum, and thus causes improper cleaning of the photosensitive drum.

As a method of removing the transfer residual toner on the intermediary transfer belt, for example, there is a method in which a voltage of an opposite polarity to a charge polarity of the toner is applied to a cleaning roller contacted to the intermediary transfer belt and the toner is transferred from the intermediary transfer belt onto the cleaning roller (Japanese Patent No. 04784858).

According to this method, by an electrostatic force generating between the toner and the cleaning roller, the toner is easily removed irrespective of a particle size of the toner when the toner is electrically charged.

Further, as another method of removing the transfer residual toner on the intermediary transfer belt, there is a method in which a developer on the intermediary transfer belt is stemmed by a blade formed of an elastic member (Japanese Patent No. 4126154).

Further, not in the wet image forming apparatus, in a dry image forming apparatus using powder toner and a carrier, a constitution in which transfer residual toner on an intermediary transfer belt is removed by two electrostatic for brushes is disclosed (Japanese Laid-Open Patent Application 2002-229384). This constitution is such that in the case of the dry image forming apparatus, not only a positive-polarity toner but also a negative-polarity toner exist in the transfer residual toner. For this reason, a constitution in which in order to prevent collection of even the toner with which polarity (positive or negative), the transfer residual toner is collected by applying a bias of a positive polarity (+) to one of the two fur brushes and by applying a bias of a negative polarity (−) to the other for brush has been disclosed.

### SUMMARY OF THE INVENTION

### Problem to be Solved by the Invention

However, in the constitution disclosed in Japanese Patent No. 04784858, removal of the transfer residual toner and removal of the paper powder on the intermediary transfer belt cannot be realized compatibly. FIG. 7 shows a result such that by an experiment of the present inventors, a relationship between each of the transfer residual toner and the paper powder with a movement ratio thereof to the cleaning roller was checked. As shown in FIG. 7, in the case where a voltage of an opposite polarity to the charge polarity of the toner is applied to the cleaning roller, the transfer residual toner can be removed, but calcium carbonate which is one component of the paper powder. On the other hand, in the case where a voltage of the same polarity as the toner charge polarity is applied to the cleaning roller, the calcium carbonate charged to the opposite polarity to the toner charge polarity can be removed, but the transfer residual toner cannot be removed. For that reason, in the constitution disclosed in Japanese Patent No. 04784858, the paper powder can be removed by the cleaning roller for removing the transfer residual toner on the intermediary transfer belt, so that there is a possibility that improper cleaning of the photosensitive drum is caused.

Further, in the constitution using the blade disclosed in Japanese Patent No. 4126154, the paper powder is sandwiched between the intermediary transfer belt and the blade, so that “slip-through” such that the toner slips through the blade without being stemmed by the blade occurs in some instances. Particularly, in the liquid developer, a particle size of the toner is small, i.e., less than 1 μm in many cases, so that the slip-through of the toner is liable to occur. Further, in the case where the intermediary transfer belt is the elastic member, unless an amount of the carrier liquid is sufficient, a frictional force between the intermediary transfer belt and the blade becomes large and the blade is turned up, and therefore, it is not easy for the blade to clean the intermediary transfer belt.

Accordingly, an object of the present invention is to provide an image forming apparatus capable of compatibly realizing removal of the transfer residual toner and removed of the paper powder on the intermediary transfer belt in the wet image forming apparatus using the liquid developer.

### Means for Solving the Problem

According to the present invention, there is provided an image forming apparatus comprising: an image bearing member for bearing an image formed with a liquid developer containing toner and a carrier liquid; a rotatable intermediary transfer member onto which the image is transferred from the image bearing member at a primary transfer portion; secondary transfer means for transferring the image from the intermediary transfer member onto a recording material at a secondary transfer portion; a first cleaning roller contacting an outer peripheral surface of the intermediary transfer member at a first cleaning portion positioned downstream of the secondary transfer portion and upstream of the primary transfer portion with respect to a rotational direction of the intermediary transfer member; a first voltage source for applying a voltage of a first polarity to the first cleaning roller; a second cleaning roller contacting the outer peripheral surface of the intermediary transfer member at a second cleaning portion positioned downstream of the first cleaning portion and upstream of the primary transfer portion with respect to the rotational direction of the intermediary transfer member; and a second voltage source for applying a voltage of a second polarity opposite to the first polarity, to the second cleaning roller.

### Effect of the Invention

According to the present invention, in the wet image forming apparatus using the liquid developer, it is possible to compatibly realized removal of the transfer residual toner and removal of the paper powder on the intermediary transfer belt.

### BRIEF DESCRIPTION OF THE DRAWINGS

FIG. 1 is a schematic sectional view of an image forming apparatus.

FIG. 2 is a schematic sectional view of an image forming portion.

FIG. 3 is a schematic sectional view of a belt cleaning device.

FIG. 4 is a schematic sectional view of another example of the image forming apparatus.

FIG. 5 is a schematic sectional view of a secondary transfer unit.

FIG. 6 is a schematic sectional view of another example of the secondary transfer unit.

FIG. 7 is a graph for illustrating a cleaning property of transfer residual toner and paper powder on an intermediary transfer belt by cleaning rollers.

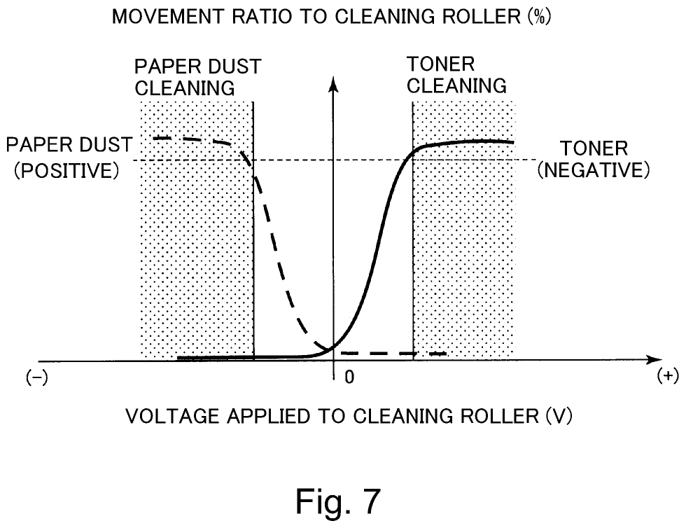

### EMBODIMENTS FOR CARRYING OUT THE INVENTION

In the following, an image forming apparatus according to the present invention will be further specifically described in accordance with the drawings.

### Embodiment 1

### 1. General Structure and Operation of Image Forming Apparatus

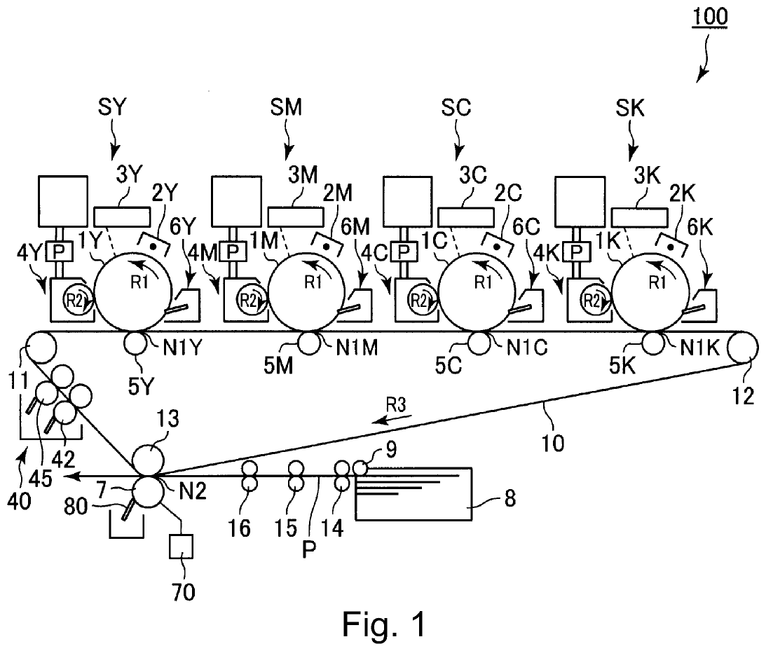

FIG. 1 is a schematic sectional view of an image forming apparatus 100 of this embodiment. The image forming apparatus 100 in this embodiment is a tandem-type wet image forming apparatus (full-color printer) capable of forming a full-color image by an electrophotographic type and employing an intermediary transfer type. The image forming apparatus 100 can form and output the full-color image on a recording material P depending on image information from an external device such as a personal computer capable of establishing communication with an apparatus main assembly or from an image reading apparatus. As the recording material P, for example, it is possible to cite cut paper of 50-400 g/m² in average bias weight, an OHP (overhead transparency) sheet, and the like.

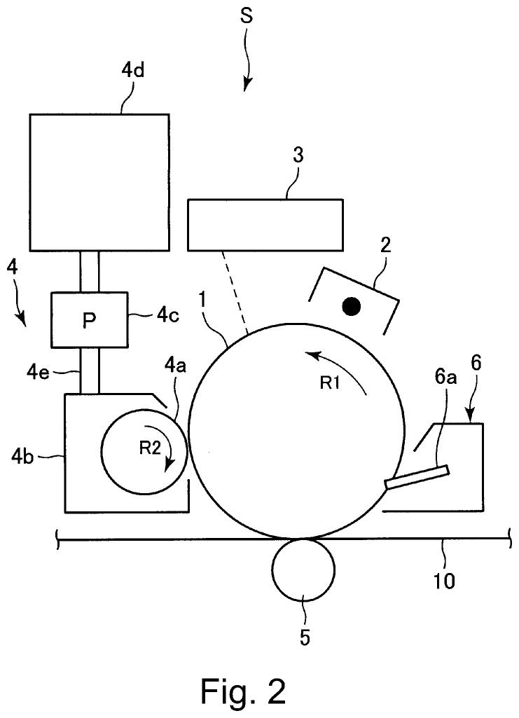

The image forming apparatus 100 includes first, second, third and fourth image forming portions (stations) SY, SM, SC and SK for forming images of yellow (Y), magenta (M), cyan (C) and black (K), respectively, as a plurality of image forming portions. The first, second, third and fourth image forming portions SY, SM, SC and SK are equidistant disposed in this order along a movement direction of an intermediary transfer belt 10 described later. As regards elements having the same or corresponding functions or structures, suffixes Y, M, C and K representing the elements each for any one of colors are omitted, and the elements will be collectively described in some instances. In this embodiment, the image forming portion S is constituted by including a photosensitive drum 1, a charging device 2, an exposure device 3, a developing device 4, a primary transfer roller 5, a drum cleaning device 6 and the like which are described later. FIG. 2 is a schematic sectional view showing a single image forming portion S as a representative.

The image forming portions includes the photosensitive drum 1, as an image bearing member, a rotatable drum-type (cylindrical) photosensitive member (electrophotographic photosensitive member). In this embodiment, the photosensitive drum 1 is constituted by forming a photosensitive layer (photoconductor) of amorphous silicon on an outer peripheral surface of an electroconductive cylinder of aluminum. Incidentally, as the photosensitive drum 1, an organic photoconductor (OPC) may also be used. In this embodiment, the photosensitive drum 1 is 84 mm in outer diameter and 380 mm in length with respect to a rotational axis direction (longitudinal direction). The photosensitive drum 1 is rotationally driven by a driving means at a predetermined peripheral speed (for example, 500 mm/sec) in an arrow R1 direction in the figure.

A surface of the rotating photosensitive drum 1 is charge-processed uniformly to a predetermined potential of a predetermined polarity by the charging device 2 as a charging means. In this embodiment, the charging device is constituted by a corona charger of scorotron type. In this embodiment, the charging provided 2 electrically charges the surface of the photosensitive drum 1 to a uniform dark-part potential (for example, −500 V) of a negative polarity. The charging device 2 charges the surface of the photosensitive drum by applying a DC voltage by an unshown charging voltage source (high-voltage source) to a discharge wire mode of tungsten or stainless steel of about 50-100 μm in diameter shielded by metal such as aluminum.

The charge-processed surface of the photosensitive drum 1 is subjected to scanning exposure to light by the exposure device 3 as an exposure means, so that an electrostatic latent image (electrostatic image) is formed on the photosensitive drum 1. In this embodiment, the exposure device 3 is constituted by a laser scanner unit. The exposure device 3 causes a laser light emitting element to emit layer light which is ON-OFF modulated on the basis of scanning line image data in which pieces of separate color image information of the respective colors are developed, and then the charge-processed surface of the photosensitive drum 1 is scanned with the laser light by using a rotating mirror. At an exposure portion of the surface of the photosensitive drum 1, a potential lowering occurs, so that a light-part potential (for example, −100 V) is formed. By this, the electrostatic latent image corresponding to the image information is formed on the surface of the photosensitive drum 1.

The electrostatic latent image formed on the photosensitive drum 1 is developed (visualized) with a liquid developer by the developing device as a developing means. The developing device 4 is constituted by including a developing roller 4a as a developer carrying member, a supply tray 4b, a circulating pump 4c, a mixer 4d, a circulating system 4e and the like. The developing roller 4a form a developing nip (developing portion) in contact with the photosensitive drum 1. The developing roller 4a is rotationally driven in an arrow R2 direction in the figure by a driving means (not shown). To the developing roller 4a, by an unshown developing voltage source (high-voltage source), a developing bias (for example, −300 V) which is a DC voltage with an intermediary value between the above-described back-part potential and light-part potential is applied. A toner proportion in which the toner cannot be occupied in the liquid developer (hereinafter referred to as “T/D”) is adjusted, and the liquid developer is stirred and thereafter is supplied to the supply tray 4b through the circulating system 4e by the circulating pump 4c. The liquid developer supplied from the supply tray 4b onto the developing roller 4a reaches a developing nip by rotation of the developing roller 4a. When the liquid developer reaches the developing nip, the toner charged to the negative potential moves to the photosensitive drum 1 at a place where the light-part potential which is a potential of the positive polarity relative to the developing bias, so that a toner image is formed (reverse development). At this time, a part of a carrier liquid on the developing roller 4a is also deposited on the photosensitive drum 1. Toner remaining on the developing roller 4a after passing through the developing nip is electrostatically collected by a development cleaning roller (not shown).

The intermediary transfer belt 10, which is an intermediary transfer member constituted by an endless belt is provided opposed to the four photosensitive drums 1. The intermediary transfer belt 10 is extended around, as a plurality of stretching rollers, a driving roller 11, a tension roller 12 and a back-up roller 13, and is stretched. The driving roller 11 is rotationally driven by a driving means (not shown), so that the intermediary transfer belt 10 is rotated (circulated and moved) in an arrow R3 direction. The tension roller 12 is pressed from an inner peripheral surface side toward an outer peripheral surface side of the intermediary transfer belt 10 with a predetermined force (for example, 80N), and imparts tension to the intermediary transfer belt 10 so that the intermediary transfer belt does not loosen. The back-up roller 13 functions as an opposite member (opposite electrode) to a secondary transfer roller described later. The intermediary transfer belt 10 is a film-shaped endless belt with a certain thickness, and an intermediary transfer belt formed of a resin such as polyimide or polyamide or a material in which an antistatic agent such as a carbon black is contained in an appropriate amount in an alloy of the resins can be used. The intermediary transfer belt 10 is formed so that surface resistivity is 1×10⁹-1×10¹³ Ω/□. Further, as the intermediary transfer belt 10, a thickness thereof is 0.04-0.1 mm.

On the inner peripheral surface side of the intermediary transfer belt 10, the primary transfer rollers 5, as primary transfer means, which are roller-type primary transfer members are disposed correspondingly to the respective photosensitive drums 1. The primary transfer roller 5 contacts the photosensitive drum 1 so as to sandwich the intermediary transfer belt 10 therebetween and forms a primary transfer nip (primary transfer portion) N1 where the photosensitive drum 1 and the intermediary transfer belt 10 are in contact with each other. To the primary transfer roller 5, by an unshown primary transfer voltage source (high-voltage source), a primary transfer bias (for example, +800 V) which is a DC voltage of an opposite polarity (positive polarity in this embodiment) to a normal charge polarity of the toner is applied so that a predetermined current (for example, 100 μA) flows. By this, an electric field is formed in the primary transfer nip N1, so that the toner image on the photosensitive drum 1 is moved and primary-transferred onto the intermediary transfer belt 10. For example, during full-color image formation, the toner images of the respective colors of yellow, magenta, cyan and black formed on the respective photosensitive drums 1 are primary-transferred onto the intermediary transfer belt 1 in the respective primary transfer nips. At that time, a part of the carrier liquid on the photosensitive drum 1 is also deposited on the intermediary transfer belt 10.

On the outer peripheral surface side of the intermediary transfer belt 10, at a position opposing the back-up roller 13, the secondary transfer roller 7, as a secondary transfer means, which is a roller-type secondary transfer member is provided. The secondary transfer roller 7 contacts the back-up roller 13 so as to sandwich the intermediary transfer belt 10 therebetween and forms a secondary transfer nip (secondary transfer portion) N2 where the secondary transfer roller 7 and the intermediary transfer belt 10 are in contact with each other. To the secondary transfer roller 7, by a secondary transfer voltage source (high-voltage source) 70, a secondary transfer bias (for example, +1500 V) which is a DC voltage of an opposite polarity (positive polarity in this embodiment) to the normal charge polarity of the toner is applied. By this, the electric field is formed in the secondary transfer nip S2, so that the toner image on the intermediary transfer belt 10 is moved and secondary-transferred onto the recording material (recording medium, sheet) P. At this time, a part of the carrier liquid on the intermediary transfer belt 10 is also deposited on the recording material P. The recording material P is drawn out from a recording material cassette 8 by a pick-up roller 9, and thereafter is fed to registration rollers 16 by feeding rollers 14 and 15 and the like. The registration rollers 16 receive the recording material P in a rest state and keep the recording material P on standby, and then send the recording material P to the secondary transfer nip N2 in synchronism with timing of the toner image on the intermediary transfer belt 10. The recording material P is introduced into the secondary transfer nip N2, and the toner is transferred onto the recording material P in a process in which the recording material P is nipped and fed by the intermediary transfer belt 10 and the secondary transfer roller 7.

The recording material P on which the toner image is transferred is separated from the intermediary transfer belt 10, and is fed to a fixing device (not shown) as a fixing means. The toner image on the recording material P is fixed on the recording material P by the fixing device. Depending on a property of the liquid developer, the fixing device, for example, heats and presses the recording material P or subjects the recording material P to ultraviolet irradiation, so that the toner image is fixed on the recording material P. Thereafter, the recording material P is discharged (outputted) to an outside of the apparatus main assembly of the image forming apparatus 10.

The toner remaining on the photosensitive drum 1 after passing through the primary transfer nip N1 (the carrier liquid also remains together with the toner on the photosensitive drum) is collected by the drum cleaning device 6 as a photosensitive member cleaning means. The drum cleaning device 6 cleans the surface of the photosensitive drum 1 so as to mechanically scrape the liquid developer on the rotating photosensitive drum 1 by a blade 6a disposed so as to contact the surface of the photosensitive drum 1. Further, the toner remaining on the intermediary transfer belt 10 after passing through the secondary transfer nip N2 (the carrier liquid also remains together with the toner) is collected by a belt cleaning device 40 as an intermediary transfer member cleaning means. The belt cleaning device 40 will be specifically described later.

Here, onto the intermediary transfer belt 10, in addition to the toner image to be transferred onto the recording material P, a toner image for density inspection and a toner image for color misregistration inspection are also transferred. These toner images for density inspection and for color misregistration inspection are not transferred onto the recording material P but are transferred onto the secondary transfer roller 7. The toner images transferred on the secondary transfer roller 7 are removed together with the carrier liquid from the secondary transfer roller 7 by a blade 80 as a secondary transfer roller cleaning member disposed so as to contact the secondary transfer roller 7.

Incidentally, in this embodiment, an intermediary transfer unit 20 is constituted by including the intermediary transfer belt 10, the stretching rollers 11 to 13 for the intermediary transfer belt 10, the primary transfer rollers 5, the belt cleaning device 40 and the like. Further, in this embodiment, peripheral speeds of the photosensitive drum 1, the developing roller 4a and the intermediary transfer belt 10 corresponding to a process speed of the image forming apparatus 100 are substantially the same.

### 2. Liquid Developer

In this embodiment, as the developer, a liquid developer in which the toner which is a dispersoid is dispersed in the carrier liquid which is a dispersion medium is used. In the liquid developer, toner which is resin particles of 1 μm in center diameter in which a pigment of each of the colors of yellow, magenta, cyan and black is incorporated is dispersed in a carrier liquid comprising a silicone solvent, hydrocarbon, ethers, or the like. Further, in the liquid developer, as needed, a toner dispersing agent, a charge control agent and the like are added. Further, a volume resistivity of the liquid developer is 1×10¹⁰ Ω·cm or more. As the carrier liquid, the carrier liquid is not limited to the above-described carrier liquid, but for example, a monomer having ultraviolet curable power, and the like are also usable. The T/D of the liquid developer is 1-10 wt. %, and a viscosity of the liquid developer is 0.5-100 cP. Incidentally, in this embodiment, as the toner, negatively chargeable toner of which normal charge polarity (charge polarity during the development) is the negative polarity is used.

### 3. Belt Cleaning Device

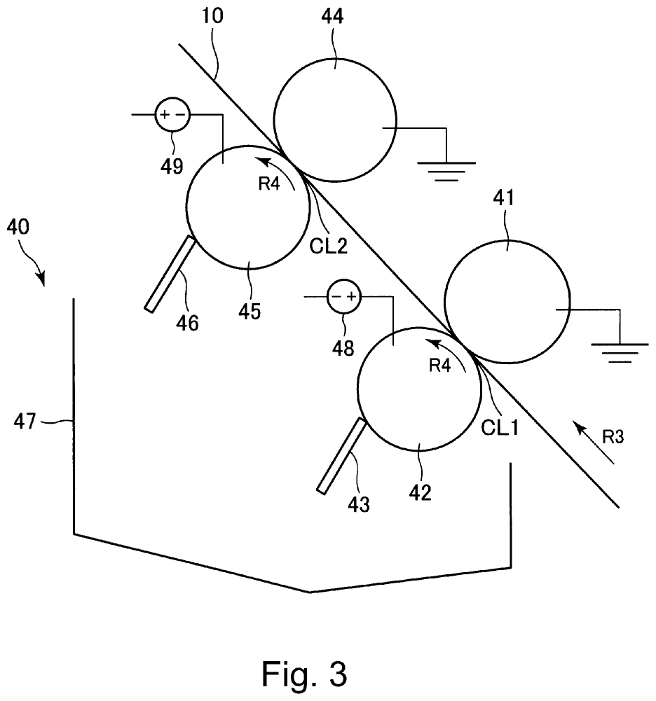

Next, the belt cleaning device 40 in this embodiment will be described. FIG. 3 is a schematic sectional view (a cross-section substantially perpendicular to a rotational axis direction of the stretching rollers for the intermediary transfer belt 10) of the belt cleaning device 40.

The belt cleaning device 40 includes, on an outer peripheral surface (toner image-carrying surface) side of the intermediary transfer belt 10, a first cleaning roller 42 as a first cleaning member and a second cleaning roller 45 as a second cleaning member. The first cleaning roller 42 is disposed downstream of the secondary transfer nip N2 and upstream of the primary transfer nip N1 (most upstream primary transfer nip N1Y) with respect to a rotational direction (movement direction, feeding direction) of the intermediary transfer belt. Further, the second cleaning roller 45 is disposed downstream of the first cleaning roller 42 and upstream of the primary transfer nip N1 (most upstream primary transfer nip N1Y) with respect to the rotational direction of the intermediary transfer belt 10. That is, with respect to the rotational direction of the intermediary transfer belt 10, the first cleaning roller 42 is disposed upstream of the second cleaning roller 45, and the second cleaning roller 45 is disposed downstream of the first cleaning roller 42.

Further, the belt cleaning device 40 includes, on the inner peripheral surface (back surface) side of the intermediary transfer belt 10, a first opposite roller 41 as a first opposite member and a second opposite roller 44 as a second opposite member. The first opposite roller 41 is disposed opposed to the first cleaning roller 42 through the intermediary transfer belt 10, and the second opposite roller 44 is disposed opposed to the second cleaning roller 45 through the intermediary transfer belt 10. The first cleaning roller 42 contacts the first opposite roller 41 so as to sandwich the intermediary transfer belt 10 therebetween, and forms a first cleaning nip (first cleaning portion) CL1 where the first cleaning roller 42 and the intermediary transfer belt 10 are in contact with each other. The second cleaning roller 45 contacts the second opposite roller 44 so as to sandwich the intermediary transfer belt 10 therebetween, and forms a second cleaning nip (second cleaning portion) CL2 where the second cleaning roller 45 and the intermediary transfer belt 10 are in contact with each other.

In this embodiment, each of the first and second cleaning rollers 42 and 45 is constituted by a roller (metal roller) made of metal (for example, stainless steel). Further, as each of the first and second rollers 41 and 44, a roller made of metal or an elastic roller in which around a core metal made of metal, an elastic layer formed of an urethane rubber or the like is coated can be used. Metal portions of the first and second opposite rollers 41 and 44 are electrically grounded (connected to the ground).

In this embodiment, each of the first and second cleaning rollers 42 and 45 is rotated in an arrow R4 direction in the figure by rotation of the intermediary transfer belt 10. Further, in this embodiment, each of the first and second rollers 41 and 44 is rotated by the rotation of the intermediary transfer belt 10. However, for example, both or either one of the first and second cleaning rollers 42 and 45 may also be constituted so as to be rotationally driven by a driving source.

Further, the belt cleaning device 40 includes a first scraper 43 as a first scraping member contacting a surface of the first cleaning roller 42 and a second scraper 46 as a second scraping member contacting a surface of the second cleaning roller 45. As the first and second scrapers 43 and 46, a sheet-like member formed of metal such as stainless steel or a resin such as polyester can be used. Each of the first and second scrapers 43 and 46 has a predetermined length and a predetermined thickness with respect to a longitudinal direction disposed substantially parallel to an associated one of the rotational axis directions of the first and second cleaning rollers 42 and 45 and with respect to a short-side direction substantially perpendicular to the longitudinal direction. Further, the first and second scrapers 43 and 46 contact the surfaces of the first and second cleaning rollers 42 and 45, respectively, so that free end portions of the first and second scrapers 43 and 46 with respect to the short-side direction face toward the upstream side of the rotational directions of the first and second cleaning rollers 42 and 45, respectively. That is, the first and second scrapers 43 and 46 contact the surfaces of the first and second cleaning rollers 42 and 45 with respect to counterdirections to the rotational directions of the first and second cleaning rollers 42 and 45, respectively.

Further, the belt cleaning device 40 includes a cleaning container 47 for accommodating the first and second cleaning rollers 42 and 45 and the first and second scrapers 43 and 46. The cleaning container 47 is connected to an unshown liquid developer collecting device through an unshown pipe passage.

The intermediary transfer belt 10 passes through the secondary transfer nip N2 and reaches the belt cleaning device 40 in a state in which the transfer residual toner and the paper powder are deposited on the outer peripheral surface of the intermediary transfer belt 10. Further, the intermediary transfer belt 10 passed through the first cleaning nip CL1 enters the second cleaning nip CL2.

Further, to the first cleaning roller 42, by a first cleaning voltage source (high-voltage source) 48, a first cleaning bias (for example, +1500 V) which is a DC voltage of an opposite polarity (positive polarity in this embodiment) to the normal charge polarity of the toner is applied. By this, an electric field is formed in the first cleaning nip CL1. The transfer residual toner on the intermediary transfer belt 10 is electrostatic collected on the first cleaning roller 42 by causing the intermediary transfer belt 10 to pass through the first cleaning nip CL1. At this time, a part of the carrier liquid on the intermediary transfer belt 10 is also deposited on the first cleaning roller 42. The toner collected on the first cleaning roller 42 is scraped together with the carrier liquid from the first cleaning roller 42 by the first scraper 43. The toner and the carrier liquid which are scraped by the first scraper 43 drop into the cleaning container 47 by gravitation, and are collected into the unshown collecting device.

Further, to the first cleaning roller 45, by a second cleaning voltage source (high-voltage source) 48, a first cleaning bias (for example, −1000 V) which is a DC voltage of the same polarity (negative polarity in this embodiment) as the normal charge polarity of the toner is applied. By this, an electric field is formed in the second cleaning nip CL2.

Herein, in the paper powder, one having a charging property of the same polarity as the normal charge polarity of the toner (i.e., the transfer residual toner), one having the opposite polarity to the normal charge polarity of the toner (i.e., the transfer residual toner), and one having a non-charging property such that the toner is not charged exist. As described above, the calcium carbonate which is one component of the paper powder principally has a property such that the calcium carbonate charges to the positive polarity which is the opposite polarity to the normal charge polarity of the toner in this embodiment.

Of the paper powder deposited on the intermediary transfer belt 10, the paper powder charged to the negative polarity which is the same polarity as the polarity of the transfer residual toner is electrostatically collected together with the transfer residual toner by the first cleaning roller 42 by causing the intermediary transfer belt 10 to pass through the first cleaning nip CL1.

On the other hand, of the paper powder deposited on the intermediary transfer belt 10, the paper powder charged to the positive polarity which is the opposite polarity to the polarity of the transfer residual toner is not collected by the first cleaning roller 42, but passes through the first cleaning nip CL1. Then, the paper powder passed through this first cleaning nip CL1 is electrostatic collected on the second cleaning roller 45 by causing the intermediary transfer belt 10 to pass through the second cleaning nip CL2. At this time, a part of the carrier liquid on the intermediary transfer belt 10 is also deposited on the second cleaning roller 45. The paper powder electrostatically collected on the second cleaning roller 45 is scraped together with the carrier liquid from the second cleaning roller 45 by the second scraper 46. The paper powder and the carrier liquid which are scraped by the second scraper 46 drop into the cleaning container 47 by gravitation, and are collected into the unshown collecting device.

Further, as regards the paper powder having the non-charging property, substantially half of the paper powder depositing on the intermediary transfer belt 10 deposits on the first cleaning roller 42 and substantially another half of the paper powder remains on the intermediary transfer belt 10, in the first cleaning nip CL1. Further, substantially half of the paper powder depositing on the intermediary transfer belt 10 deposits on the second cleaning roller 45 and substantially another half of the paper powder remains on the intermediary transfer belt 10, in the second cleaning nip CL2. Thus, the paper powder having the non-charging property is also sufficiently collected by the first and second cleaning rollers 42 and 45.

Incidentally, in this embodiment, the voltage of the opposite polarity to the normal charge polarity of the toner was applied to the first cleaning roller 42, and the voltage of the same polarity as the normal charge polarity of the toner was applied to the second cleaning roller 45. However, to the first and second cleaning rollers 42 and 45, the voltages of polarities opposite to those in this embodiment may also be applied, respectively. To the first cleaning roller 42, by applying the voltage of the same polarity as the normal charge polarity of the first cleaning roller 42 it is possible to decrease an amount of the paper powder reaching the second cleaning nip CL2. By this, it is possible to reduce probability that the paper powder is sandwiched between the second cleaning roller 45 and the intermediary transfer belt 10 and the toner passes through the second cleaning roller 45.

Further, in this embodiment, the belt cleaning device 40 included the two cleaning rollers as a plurality of cleaning rollers, but may also include three or more cleaning rollers. In this case, for example, voltages of different polarities can be alternately applied to the plurality of cleaning rollers along the movement direction of the intermediary transfer belt 10.

As described above, according to this embodiment, in the wet image forming apparatus, the first and second cleaning rollers 42 and 45 are provided on the outer peripheral surface side of the intermediary transfer belt 10, and the voltages different in polarity from each other are applied to the first and second cleaning rollers 42 and 45, respectively. By this, the transfer residual toner and the paper powder having electric charges of the opposite polarity to the transfer residual toner can be electrostatically removed from the intermediary transfer belt 10. Further, the belt cleaning device 40 is provided with a plurality (two in this embodiment) of cleaning rollers, and a contact frequency between the paper powder and the cleaning rollers is increased, so that a removal ratio of the paper powder having the non-charging property, which cannot be electrostatically removed can be enhanced. By this, it becomes possible to compatibly realize the removal of the transfer residual toner and the removal of the paper powder on the intermediary transfer belt 10.

### Embodiment 2

Next, another embodiment of the present invention will be described. Basic constitutions and operations of an image forming apparatus in this embodiment are the same as those of the image forming apparatus in the embodiment 1. Accordingly, in the image forming apparatus in this embodiment, elements having the same or corresponding functions and constitutions as those in the image forming apparatus in the embodiment 1 are represented by the same reference numerals or symbols as those in the embodiment 1 and will be omitted from detailed description.

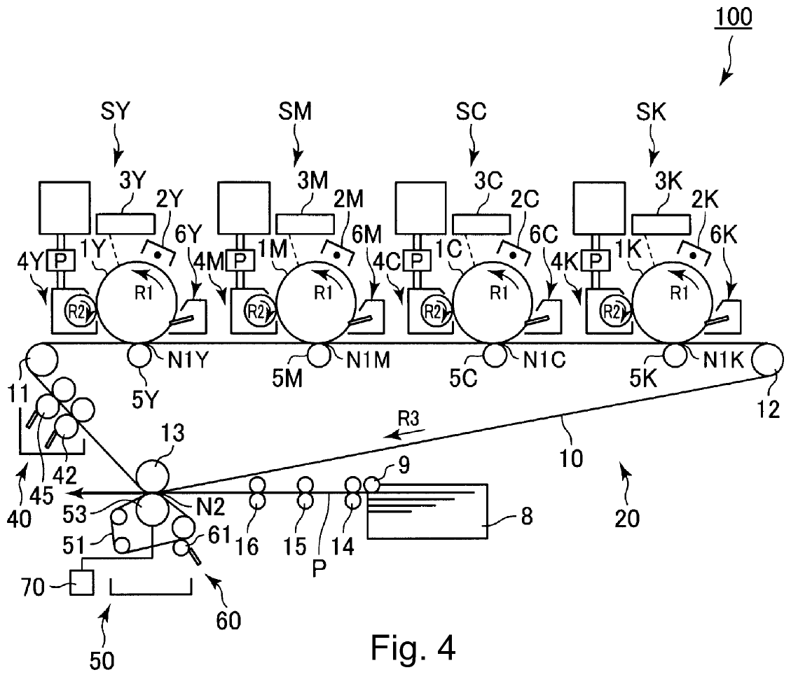

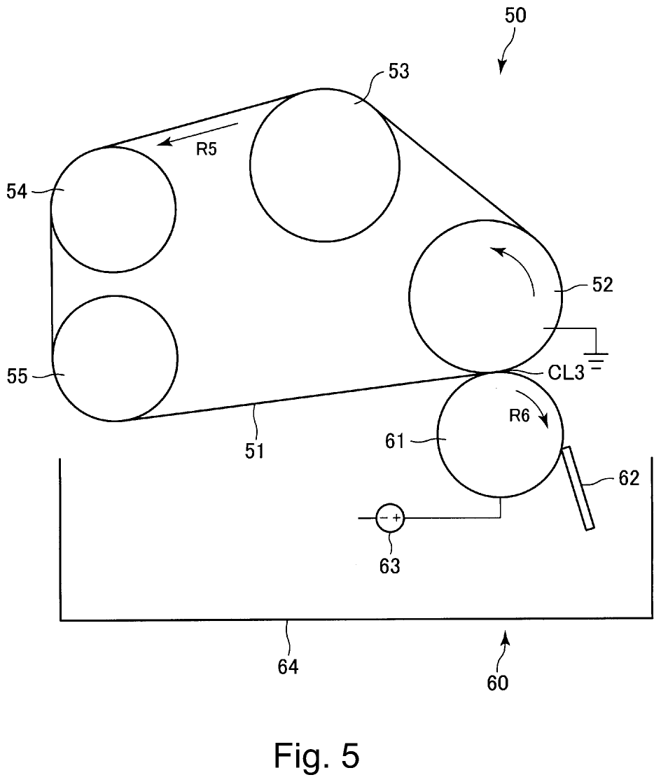

FIG. 4 is a schematic sectional view of an image forming apparatus of this embodiment. The image forming apparatus 100 of this embodiment is different from the image forming apparatus 100 of the embodiment 1 in that the image forming apparatus 100 of this embodiment includes a secondary transfer belt unit 50 as the secondary transfer means. FIG. 5 is a schematic sectional view (cross-section substantially perpendicular to a rotational axis direction of stretching rollers for a secondary transfer belt 51 described later) of the secondary transfer belt unit 50 in this embodiment.

The secondary transfer belt unit 50 includes the secondary transfer belt 51 as a secondary transfer member constituted by an endless belt. The secondary transfer belt 51 is extended around, as a plurality of stretching rollers, a secondary transfer belt driving roller 52, a secondary transfer roller 53, a separation roller 54 and a secondary transfer roller tension roller 55 and is stretched by these rollers. The secondary transfer belt driving roller 52 is rotationally driven by a driving means (not shown in the figure), so that the secondary transfer belt 51 is rotated (circulated and moved) in an arrow R5 direction in the figure. The secondary transfer roller 53 transfers the toner image from the intermediary transfer belt 10 onto the recording material P as described later. The separation roller 58 curvature-separates the recording material P from the secondary transfer belt 51. The secondary transfer belt tension roller 55 is pressed from an inner peripheral surface side toward an outer peripheral surface side of the secondary transfer belt 51 with a predetermined force, and imparts tension to the secondary transfer belt 51 so that the intermediary transfer belt 51 does not loosen. The secondary transfer belt 51 nips and conveys the recording material P, fed to the secondary transfer nip N2, between itself and the intermediary transfer belt 10. The secondary transfer belt 51 is a film-shaped endless belt with a certain thickness, and an intermediary transfer belt formed of a resin such as polyimide or polyamide or a material in which an antistatic agent such as a carbon black is contained in an appropriate amount in an alloy of the resins can be used. The secondary transfer belt 51 is formed so that surface resistivity is 1×10⁹-1×10¹³ Ω/□. Further, as the secondary transfer belt 51, a thickness thereof is 0.04-0.1 mm.

The secondary transfer roller 53 contacts the back-up roller 13 so as to sandwich the secondary transfer belt 51 and the intermediary transfer belt 10 therebetween and forms a secondary transfer nip (secondary transfer portion) N2 where the secondary transfer belt 51 and the intermediary transfer belt 10 are in contact with each other. To the secondary transfer roller 53, by a secondary transfer voltage source (high-voltage source) 70, a secondary transfer bias (for example, +1500 V) which is a DC voltage of an opposite polarity (positive polarity in this embodiment) to the normal charge polarity of the toner is applied. By this, the electric field is formed in the secondary transfer nip S2, so that the toner image on the intermediary transfer belt 10 is moved and secondary-transferred onto the recording material (recording medium, sheet) P.

Onto the secondary transfer belt 51, a toner image for density inspection and a toner image for color misregistration inspection which are not transferred onto the recording material P are transferred. In this embodiment, the secondary transfer belt unit 50 is provided with a secondary transfer belt cleaning provided 60 as a secondary transfer belt cleaning means in order to remove the toner image transferred on the secondary transfer belt 51.

The secondary transfer belt cleaning device 60 includes a third cleaning roller 61 as a third cleaning member on the outer peripheral surface (toner image-carrying surface) side of the secondary transfer belt 51. The third cleaning roller 61 is disposed opposed to the secondary transfer belt driving roller 52 through the secondary transfer belt 51. In this embodiment, the third cleaning roller 61 is rotated in an arrow R6 direction in the figure by rotation of the intermediary transfer belt 10. However, the third cleaning roller 61 may also be constituted so as to be rotationally driven by a driving source. The third cleaning roller 61 contacts the secondary transfer belt driving roller 52 so as to sandwich the secondary transfer belt 51, and forms a third cleaning nip (third cleaning portion) CL3 in which the third cleaning roller 61 and the secondary transfer belt 51 are in contact with each other. In this embodiment, the secondary transfer belt driving roller 52 functions as a third opposite member.

Further, the secondary transfer belt cleaning device 60 includes a third scraper 62 as a third scraping member contacting a surface of the third cleaning roller 61. As the third scrapers 62, a member similar to the member as the first scraper 43 can be used.

Further, the secondary transfer belt cleaning device 60 includes a secondary transfer belt cleaning container 614 for accommodating the third cleaning roller 61 and the third scraper 62. The secondary transfer roller cleaning container 64 is connected to an unshown liquid developer collecting device through an unshown pipe passage.

In this embodiment, the third cleaning roller 61 is constituted by a roller made of metal (for example, stainless steel). Further, in this embodiment, the secondary transfer belt driving roller 52 is constituted by an elastic roller in which around a core metal made of metal, an elastic layer formed of an urethane rubber is coated. A metal portion of the secondary transfer belt driving roller 52 is electrically grounded. A thickness of the elastic layer of the secondary transfer belt driving roller 52 is 0.01 mm-0.1 mm.

Further, to the third cleaning roller 61, by a third cleaning voltage source (high-voltage source) 63, a third cleaning bias (for example, +1500 V) which is a DC voltage of an opposite polarity (positive polarity in this embodiment) to the normal charge polarity of the toner is applied. By this, an electric field is formed in the third cleaning nip CL3. The transfer residual toner on the secondary transfer belt 51 is electrostatic collected on the third cleaning roller 61 by causing the secondary transfer belt 51 to pass through the third cleaning nip CL3. At this time, a part of the carrier liquid on the secondary transfer belt 51 is also deposited on the third cleaning roller 61. The toner collected on the third cleaning roller 61 is scraped together with the carrier liquid from the third cleaning roller 61 by the third scraper 62. The toner and the carrier liquid which are scraped by the third scraper 62 drop into the secondary transfer belt cleaning container 64 by gravitation, and are collected into the unshown collecting device. Thus, the toner image transferred on the secondary transfer belt 51 is removed from the secondary transfer belt 51 by the third cleaning roller 61.

Here, similarly as the intermediary transfer belt 10, the paper powder also deposits on the secondary transfer belt 51 in some cases. Of the paper powder deposited on the secondary transfer belt 51, the paper powder charged to the negative polarity which is the same polarity as the normal charge polarity of the toner is electrostatically collected together with the transfer residual toner by the third cleaning roller 61 by causing the secondary transfer belt 51 to pass through the third cleaning nip CL3. On the other hand, of the paper powder deposited on the secondary transfer belt 51, the paper powder charged to the positive polarity which is the opposite polarity to the normal charge polarity of the toner is not collected by the third cleaning roller 61, but passes through the third cleaning nip CL3. Then, the paper powder passed through this first cleaning nip CL1 is removed from the secondary transfer belt 51 in the following manner by causing the secondary transfer belt 51 to pass through the secondary transfer nip N2. That is, by the electric field formed in the secondary transfer nip N2, the paper powder is transferred onto the intermediary transfer belt 10 or the back surface (surface opposite in side from the surface onto which the toner image is transferred) of the recording material P passing through the secondary transfer nip N2, and is removed from the secondary transfer belt 51.

Further, as regards the paper powder having the non-charging property, substantially half of the paper powder depositing on the secondary transfer belt 51 deposits on the third cleaning roller 61 and substantially another half of the paper powder remains on the secondary transfer belt 51, in the third cleaning nip CL3. Further, substantially half of the paper powder depositing on the secondary transfer belt 51 deposits on the intermediary transfer belt 10 and the back surface of the recording material P and substantially another half of the paper powder remains on the secondary transfer belt 51, in the secondary transfer nip N2. Thus, the paper powder having the non-charging property is also sufficiently collected.

In the constitution in which the toner is scraped from the secondary transfer roller 7 as the secondary transfer member by the blade 80 as in the embodiment 1, the paper powder is sandwiched between the secondary transfer roller 7 and the blade 80, so that the toner slips through the blade 80 in some instances. On the other hand, the secondary transfer belt 51 is used as the secondary transfer member as in this embodiment, and the toner on the secondary transfer belt 51 is electrostatically collected, so that a cleaning property of the toner transferred on the secondary transfer means is improved compared with the constitution of the embodiment 1.

As described above, according to this embodiment, an effect similar to the embodiment 1 is obtained, and at the same time, the cleaning property of the toner transferred on the secondary transfer means is improved.

### Embodiment 3

Next, another embodiment of the present invention will be described. Basic constitutions and operations of an image forming apparatus in this embodiment are the same as those of the image forming apparatus in the embodiments 1 and 2. Accordingly, in the image forming apparatus in this embodiment, elements having the same or corresponding functions and constitutions as those in the image forming apparatus in the embodiments 1 and 2 are represented by the same reference numerals or symbols as those in the embodiment 1 and will be omitted from detailed description.

In this embodiment, an image forming apparatus 100 includes, similarly as the embodiment 2, a secondary transfer belt unit 50 as the secondary transfer means. The image forming apparatus 100 of this embodiment is different from the image forming apparatus 100 of the embodiment 2 in that a secondary transfer belt cleaning device 60 of the secondary transfer belt unit 50 includes a fourth cleaning roller 65 described later.

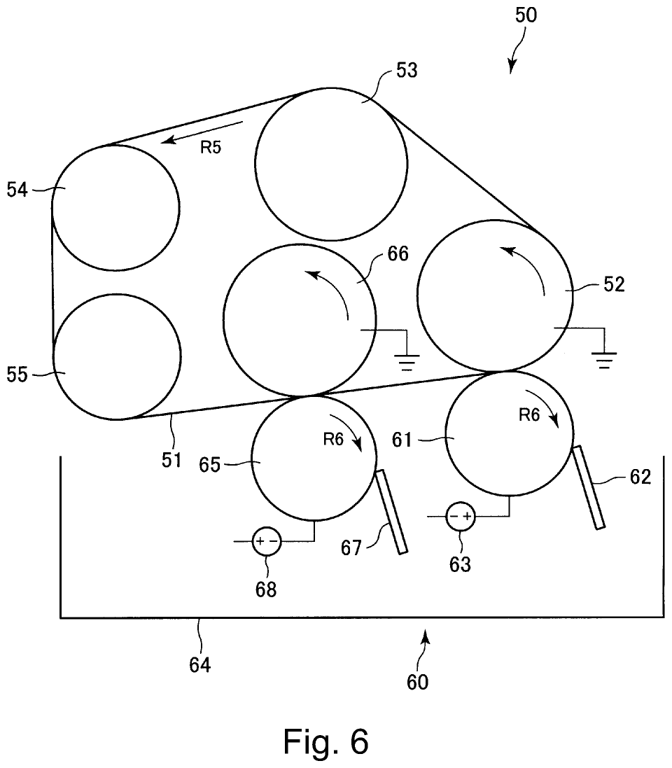

FIG. 6 is a schematic sectional view (cross-section substantially perpendicular to a rotational axis direction of stretching rollers for the secondary transfer belt 51 of the secondary transfer belt unit 50 in this embodiment.

In this embodiment, the secondary transfer belt cleaning device 60 includes, in addition to the constitution of the embodiment 2, a fourth cleaning roller 65 as a fourth member on an outer peripheral surface (toner image-carrying surface) side of the secondary transfer belt 51. The fourth cleaning roller 65 is disposed downstream of the tension roller 55 and upstream of the third cleaning roller 61 with respect to the rotational direction (movement direction, feeding direction) of the secondary transfer belt 51. That is, with respect to the rotational direction of the secondary transfer belt 51, the fourth cleaning roller 65 is disposed upstream of the third cleaning roller 61, and the third cleaning roller 61 is disposed downstream of the fourth cleaning roller 65 (upstream of the secondary transfer nip N2). As the fourth cleaning roller 65, one similar to the first cleaning roller 42 can be used.

Further, in this embodiment, the secondary transfer belt cleaning device 60 includes, on the inner peripheral surface (back surface) side of the secondary transfer belt 51, a fourth opposite roller 66 as a fourth opposite member. The fourth opposite roller 66 is disposed opposed to the fourth cleaning roller 65 through the secondary transfer belt 51. The fourth cleaning roller 65 contacts the fourth opposite roller 66 so as to sandwich the secondary transfer belt 51 therebetween, and forms a fourth cleaning nip (fourth cleaning portion) CL4 where the fourth cleaning roller 65 and the secondary transfer belt 51 are in contact with each other. As the fourth opposite roller 66, one similar to the first opposite roller 41 can be used. Incidentally, a metal portion of the fourth opposite roller 66 is electrically grounded.

In this embodiment, the fourth cleaning roller 65 is rotated in an arrow R6 direction in the figure by rotation of the secondary transfer belt 51. Further, in this embodiment, the fourth opposite roller 66 is rotated by the rotation of the secondary transfer belt 51. However, for example, the fourth cleaning roller 66 may also be constituted so as to be rotationally driven by a driving source.

Further, in this embodiment, the secondary transfer belt cleaning device 60 includes a fourth scraper 67 as a fourth scraping member contacting a surface of the fourth cleaning roller 65. As the fourth scraper 67, one similar to the first scraper 43 can be used.

In this embodiment, the secondary transfer belt 51 passed through the secondary transfer nip N2 enters the fourth cleaning nip CL4 before passes through the third cleaning nip CL3. Further, in this embodiment, to the fourth cleaning roller 65, by a fourth cleaning voltage source (high-voltage source) 68, a fourth cleaning bias (for example, −1000 V) which is a DC voltage of the same polarity (negative polarity in this embodiment) as the normal charge polarity of the toner is applied. By this, an electric field is formed in the fourth cleaning nip.

In this embodiment, of the paper powder deposited on the secondary transfer belt 51, the paper powder charged to the positive polarity which is the opposite polarity to the normal charge polarity of the toner is electrostatically collected by the fourth cleaning roller 65 by causing the secondary transfer belt 51 to pass through the fourth cleaning nip CL4. At this time, a part of the carrier liquid on the secondary transfer belt 51 is also deposited on the fourth cleaning roller 65. The paper powder electrostatically collected on the fourth cleaning roller 65 is scraped together with the carrier liquid from the fourth cleaning roller 65 by the fourth scraper 67. The paper powder and the carrier liquid which are scraped by the fourth scraper 67 drop into the cleaning container 64 by gravitation, and are collected into the unshown collecting device. Further, as regards the paper powder having the non-charging property, substantially half of the paper powder depositing on the intermediary transfer belt 10 deposits on the fourth cleaning roller 64 and substantially another half of the paper powder remains on the secondary transfer belt 51, in the fourth cleaning nip CL4. Incidentally, action of the third cleaning roller 61 is similar to the action in the embodiment 2.

As in this embodiment, the fourth cleaning roller 65 is provided, it is possible to decrease an amount of the paper powder reaching the third cleaning nip CL3. By this, it is possible to reduce probability that the paper powder is sandwiched between the third cleaning roller 61 and the secondary transfer belt 51 and the toner passes through the third cleaning roller 61. For that reason, according to this embodiment, the cleaning property of the toner transferred on the secondary transfer means is further improved than in the embodiment 2.

As described above, according to this embodiment, effects similar to the embodiments 1 and 2 are obtained, and at the same time, the cleaning property of the toner transferred on the secondary transfer means is further improved. Further, deposition of the paper powder, deposited on the secondary transfer belt 51, on the intermediary transfer belt 10 is suppressed, so that a load of paper powder removal on the belt cleaning device 40 can be alleviated.

### Others

As described above, the present invention was described in accordance with specific embodiments, but the present invention is not limited to the above-described embodiments.

In the above-described embodiments, the intermediary transfer member was formed of the endless belt, but the present invention is not limited thereto, and the intermediary transfer member is may also be a drum-shaped member or the like constituted by, for example, stretching the film around a frame.

Further, in the above-described embodiments, the opposite member for the cleaning roller was the roller-shaped member, but the present invention is not limited thereto. The opposite member may also be a member, for example, a pad-shaped, a sheet-shaped or a brush-shaped member or the like, not only which sandwich the belt between itself and the cleaning roller, but also which slides on the inner peripheral surface of the belt with movement of the belt.

Further, in the above-described embodiments, only a principal part relating to the toner image formation and the transfer was described, but the present invention can be carried out in various forms, such as printers, various printing machines, copying machines, FAX, multi-function machines and the like, by adding necessary device, equipment, casing structures, or the like.

### INDUSTRIAL APPLICABILITY

According to the present invention, there is provided the wet image forming apparatus which uses the liquid developer and which is capable of compatibly realizing removal of the transfer residual toner and removal of the paper powder on the intermediary transfer belt.

The present invention is not limited to the above-described embodiments, but can be variously changed and modified without departing from the spirit and the scope of the present invention. Accordingly, the following claims are attached for making the scope of the present invention public.

The present application claims priority on the basis of Japanese Patent Application No. 2018-110747 filed on Jun. 8, 2018, which is hereby incorporated by reference herein in its entirety.

1. An image forming apparatus comprising:
an image bearing member for bearing an image formed with a liquid developer containing toner and a carrier liquid;
a rotatable intermediary transfer member onto which the image is transferred from said image bearing member at a primary transfer portion;
secondary transfer means for transferring the image from said intermediary transfer member onto a recording material at a secondary transfer portion;
a first cleaning roller contacting an outer peripheral surface of said intermediary transfer member at a first cleaning portion positioned downstream of the secondary transfer portion and upstream of the primary transfer portion with respect to a rotational direction of said intermediary transfer member;
a first voltage source for applying a voltage of a first polarity to said first cleaning roller;
a second cleaning roller contacting the outer peripheral surface of said intermediary transfer member at a second cleaning portion positioned downstream of said first cleaning portion and upstream of the primary transfer portion with respect to the rotational direction of said intermediary transfer member; and
a second voltage source for applying a voltage of a second polarity opposite to the first polarity, to said second cleaning roller.

2. An image forming apparatus according to claim 1, wherein said intermediary transfer member is formed of an endless belt.

3. An image forming apparatus according to claim 2, comprising a first opposite member provided opposed to said first cleaning roller through said intermediary transfer member and a second opposite member provided opposed to said second cleaning roller through said intermediary transfer member,
wherein said first cleaning roller contacts said first opposite member through said intermediary transfer member, and said second cleaning roller opposites said second opposite member through said intermediary transfer member.

4. An image forming apparatus according to claim 1, wherein said secondary transfer means includes a rotatable secondary transfer member for forming the secondary transfer portion in contact with said intermediary transfer member, and
wherein said image forming apparatus comprises a third cleaning roller contacting the outer peripheral surface of said secondary transfer member at a third cleaning portion, and a third voltage source for applying, to said third cleaning roller, a voltage of an opposite polarity to a normal charge polarity of the toner.

5. An image forming apparatus according to claim 4, wherein said secondary transfer member is formed of an endless belt.

6. An image forming apparatus according to claim 5, comprising a third opposite member provided opposed to said third cleaning roller through said secondary transfer member,
wherein said third cleaning roller contacts said third opposite member through said second transfer member.

7. An image forming apparatus according to claim 4, comprising:
a fourth cleaning roller contacting the outer peripheral surface of said secondary transfer member at a fourth cleaning portion, and
a fourth voltage source for applying a voltage of the same polarity as a normal charge polarity of the toner.

8. An image forming apparatus according to claim 7, wherein with respect to the rotational direction of said second transfer member, the third cleaning portion is positioned downstream of the fourth cleaning portion and upstream of the second transfer portion, and the fourth cleaning portion is positioned downstream of the second transfer portion and upstream of the third cleaning portion.

9. An image forming apparatus according to claim 7, wherein said secondary transfer member is formed of an endless belt.

10. An image forming apparatus according to claim 9, comprising a third opposite member provided opposed to said third cleaning roller through said secondary transfer member and a fourth opposite member provided opposed to said fourth cleaning roller through said secondary transfer member,
wherein said third cleaning roller contacts said first opposite member through said secondary transfer member, and said fourth cleaning roller opposites said second opposite member through said secondary transfer member.

11. An image forming apparatus according to claim 1, wherein the first polarity is an opposite polarity to a normal charge polarity of the toner.

12. An image forming apparatus according to claim 1, wherein said secondary transfer means includes a rotatable secondary transfer member for forming the secondary transfer portion in contact with said intermediary transfer member, and
wherein said secondary transfer member is constituted so as to be electrostatically cleaned only be a single third cleaning roller, and to said third cleaning roller, only a voltage of an opposite polarity to a normal charge polarity of the toner is applied.
